(19) United States
(12) Patent Application Publication
(10) Pub. No.: US 2012/0132023 A1
(43) Pub. Date: May 31, 2012

(54) GEAR WHEEL

(76) Inventor: Christer Wallén, Södertälje (SE)

(21) Appl. No.: 13/389,327

(22) PCT Filed: Aug. 25, 2010
(86) PCT No.: PCT/SE2010/050913

§ 371 Date: Feb. 7, 2012

(30) Foreign Application Priority Data
Sep. 1, 2009 (SE) 0950625-4

(51) Int. Cl. F16H 55/12; F16H 57/02

(52) U.S. Cl. 74/412 R; 74/446

(57) ABSTRACT

The invention relates to a gear wheel (10; 20) comprising: a hub (15; 25) with respective first and second axial ends and intended to be arranged round an axis of rotation, at least one of which first and second axial ends of the hub has integral coupling devices (16; 26) intended to lock the gear wheel (10; 20) rotationally in relation to the gear wheel hub of an adjacent gear wheel; a circular gear ring (11; 21) with respective first and second axial ends and an outer periphery which is provided with a toothed rim (12; 22); and at least one intermediate wall (14; 24) which links the gear ring (11; 21) and the hub (15; 25) in such a way that the hub (15; 25) is fixed at substantially the centre of the gear ring (11; 21); which gear ring (11; 21) and hub (15, 25) are two separate parts joined together by an fastening connection (17; 27) to form a gear wheel (10; 20). The gear wheel according to the invention is characterised in that the axial ends of the hub (15; 25) end at or within the plane which is defined by the axial ends of the gear ring (11; 21) transversely in relation to the longitudinal shaft round which the gear wheel is intended to be arranged.

### CROSS-REFERENCE TO RELATED APPLICATIONS

The present application is a 35 U.S.C. §§371 national phase conversion of PCT/SE2010/050913, filed Aug. 25, 2010, which claims priority of Swedish Application No. 0950625-4 filed September 1, 2009, the contents of which are incorporated by reference herein. The PCT International Application was published in the English language.

### TECHNICAL FIELD

The invention relates to a gear wheel

### BACKGROUND

Gear wheels of different sizes and configurations are used in gearboxes to permit desired variations in rotation speed and power transmission. In a gearbox, gear wheels are arranged around a longitudinal mainshaft and a countershaft. Each gear wheel has a hub which surrounds the shaft and which is located at the center of a gear ring provided with teeth around its outer periphery. Gear wheels arranged along the shaft are coupled via their hubs to adjacent gear wheels to prevent relative rotation round the shaft. However, this means that the hubs have to be longer than the gear ring to ensure reliable engagement between adjacent hubs, resulting in there being a gap between neighboring gear rings. The width of the gear ring is dimensioned on the basis of the torque which the ring is to transmit, and the gaps then result in an increase in the total length of the gearbox. A variant gear wheel intended to solve this problem and described in EP 1 464 874 has a hub with teeth which are not longer than the length of the gear ring. These teeth are manufactured as a separate part which is fastened thereafter to a forged gear wheel hub. However, a gear wheel with this configuration is expensive to manufacture.

There is therefore a need for a gear wheel which permits better utilisation of the available space in the gearbox and which can be manufactured at a favorable cost.

### SUMMARY OF THE INVENTION

This object is achieved by a gear wheel according to the independent claim which comprises a hub, a circular gear ring and at least one intermediate wall which links the gear ring and the hub. At least one of the axial ends of the hub has integral coupling devices intended to lock the gear wheel rotationally in relation to the hubs of adjacent gear wheels, and the axial end/ends of the hub which each comprise a coupling device end at or within the plane which is defined by the corresponding axial end of the gear ring transversely in relation to the longitudinal shaft around which the gear wheel is intended to be arranged. The gear ring and the hub are two separate parts which are manufactured separately in order to be ultimately joined together by one or more fastening connections to form a gear wheel.

With the above construction of the gear wheel, the hub and the gear ring can be manufactured and machined separately before they are joined together, making it possible to achieve a hub with teeth which do not extend further axially than the gear ring, resulting in a very positive effect on the overall length of, for example, a gearbox which comprises a number of gear wheels arranged side by side in it.

The gear wheel according to the invention performs better than a conventional gear wheel because all the surfaces of the constituent parts can be machined with greater precision, whereby the gear wheel will be better balanced and hence generate less vibration, with consequent reduction of the risk of breakdowns in the longer term.

The intermediate wall of the gear wheel may either be integral with the hub or the gear ring or be a separate part.

The gear wheel according to the invention also permits the choice of different materials for its various parts, which may have a positive effect on both the performance of the gear wheel in terms of materials and machining cost.

The gear wheel according to the invention also allows the quality of the various parts to be enhanced in that their accessibility for machining is significantly facilitated and their processing can be completed before they are joined together.

Another advantage of the gear wheel according to the invention is that it can be configured in a more advantageous way by manufacturing the various parts separately before putting them together. The more optimised configuration permits further reduction of thickness and amounts of material used in certain parts of the gear wheel. The more optimised configuration of the gear wheel may also mean that currently existing apertures and holes required for manufacture by existing methods can be eliminated, which may have positive effects on strength etc.

The gear wheel according to the invention also makes it possible for the intermediate wall to be away from the center line of the gear wheel, which may be of relevance if the loads on the gear wheel are for any reason greater on one side than the other.

In an embodiment of the gear wheel according to the invention, the gear ring, intermediate wall and/or hub are made of different materials, which makes it possible to optimise the various parts independently of one another.

In an embodiment of the gear wheel according to the invention, the gear ring and the hub are joined together via two intermediate walls which extend in a substantially axial direction from the hub to the gear ring. This embodiment may, for example, be very advantageous if the load on the gear wheel is large or if a space between the two walls may possibly be usable for a cooling or lubricating medium.

In an embodiment of the gear wheel according to the invention, the fastening connection takes the form of a press fastening. The axial length of the intermediate wall is then somewhat longer than the distance between the hub and the inside of the gear ring so that the necessary force for keeping the various parts fixed relative to one another is generated when the hub and the intermediate wall are pressed into the space at the centre of the gear ring.

In an embodiment of the gear wheel according to the invention, the fastening connection takes the form of a welded connection. The welded connection may either be of a conventional type whereby material is added for the weld seam, or a welded connection generated by friction welding whereby the materials in the contact surfaces between the adjacent parts become plasticised and are thereby joined together.

In an embodiment of the gear wheel according to the invention, the fastening connection takes the form of an adhesive connection or a threaded connection.

Combinations of these various types of fastening connection are also conceivable to increase the reliability of the fastening connection, or if the materials which the parts are made of entail specific requirements.

In an embodiment of the gear wheel according to the invention, the inside of the gear ring has one or more protruding bulges against which the intermediate wall can bear. This configuration of the inner side of the gear ring facilitates the manufacture of the gear wheel in that the intermediate wall can be allowed to rest against this bulge until the parts are fastened together permanently.

In an embodiment of the gear wheel according to the invention, the intermediate wall is provided with one or more recesses to reduce the weight of the gear wheel and the amount of material used. This may lead to significant savings if the recesses are situated in the regions of the intermediate wall where the loads are small.

The invention also refers to a gearbox comprising at least two gear wheels according to the invention.

### BRIEF DESCRIPTION OF DRAWINGS

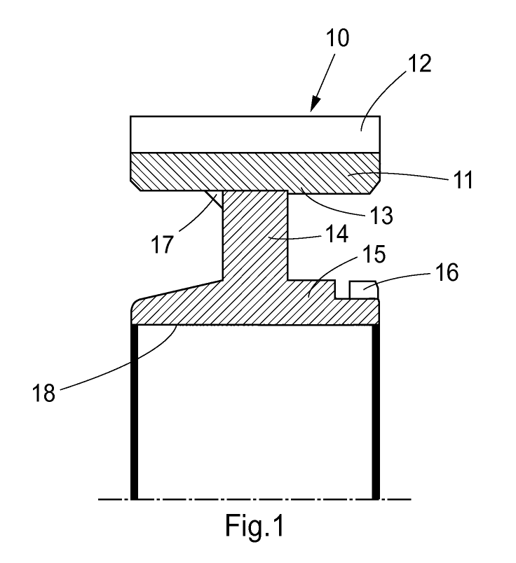

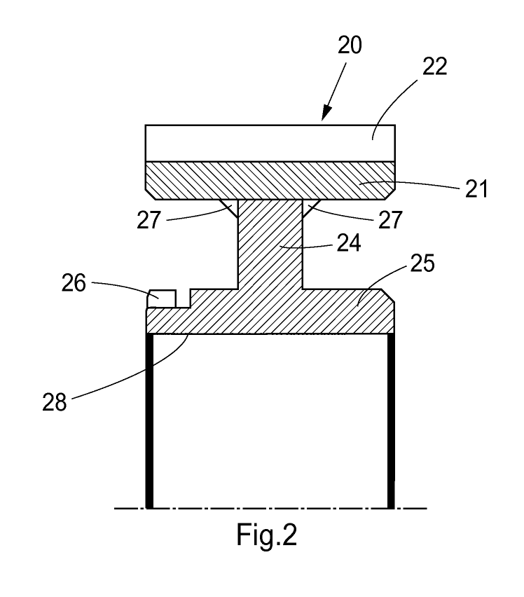

The invention is explained in more detail below with reference to the drawings, which show a half cross-section of a gear wheel, viz. a cross-section out from the center of the gear wheel to its toothed rim. FIG. 1 shows a first embodiment of a gear wheel according to the invention, and FIG. 2 a second embodiment of a gear wheel according to the invention.

### DETAILED DESCRIPTION OF THE INVENTION

FIG. 1 shows a gear wheel 10 comprising a circular gear ring 11 provided with a toothed rim 12 round its outer periphery. The teeth on this toothed rim 12 may be straight or oblique and be dimensioned on the basis of the expected loads which the gear wheel 10 is intended to transmit. The axial length (width) of the gear ring 11, and hence also of the toothed rim 12, is based on the loads to be transmitted by the gear wheel 10. The gear wheel 10 also comprises an intermediate wall 14 which extends substantially axially outwards from a hub 15 situated at the center of the gear wheel. In this embodiment of the gear wheel, the intermediate wall 14 is an integral part of the hub but may also take the form of a completely separate part intended to be fastened to the gear ring and the hub during one of the manufacturing stages. The intermediate wall 14 links the gear ring 11 and the hub 15.

With a view to facilitating the manufacture of the gear wheel 10, the inside of the gear ring may be provided with a supporting bulge 13 against which the intermediate wall 14 can bear until a permanent fastening connection 17, in this case a welded connection, which fixes the various parts to one another is in place at the transition between the gear ring 11 and the intermediate wall 14. The bulge 13 is usually so positioned that the intermediate wall 14 is situated at the center of the gear wheel 10 to prevent oblique loads in the gear wheel which might give rise to angular errors between various components. The gear wheel may also comprise two or more intermediate walls preferably situated symmetrically in the gear wheel. Supporting bulges will then be used with advantage for each intermediate wall.

The hub 15 has a substantially circular cylindrical shape with a central circular hole 18 running through it for an undepicted shaft. One axial end of the hub is provided with coupling teeth 16 to couple the gear wheel 10 rotationally to an adjacent gear wheel provided with corresponding coupling teeth. If the gear wheel is to be rotationally coupled to adjacent gear wheels on both sides, both ends of the hub are provided with teeth. The axial end or ends of the hub which are provided with coupling teeth 16 end at or within the plane which is defined by the corresponding axial ends of the gear ring 11 transversely in relation to the longitudinal shaft round which the gear wheel is intended to be arranged.

The coupling teeth 16 are directed either in a radial direction from the end surfaces of the hub 15 or in an axial direction from the end surfaces of the hub. However, the coupling teeth 16 never extend in an axial direction further than the gear ring 11, to minimise the undesirable space which is formed between adjacent gear rings if the length of the hub 15 is greater than that of the gear ring.

FIG. 2 shows a second embodiment of a gear wheel 20 according to the invention. This gear wheel 20 comprises parts similar to those described above, viz. a gear ring 21 with toothed rim 22, an intermediate wall 24 and a hub 25 with coupling teeth 26 arranged in association with one end of the hub 25, and a substantially circularly positioned hole 28 for the shaft around which the gear wheel 20 is intended to be arranged. In this case, however, the inside of the gear ring 21 is substantially straight, with no supporting bulge, and the intermediate wall 24 and the gear ring 21 are joined together by a welded connection 27 associated with the transition between the intermediate wall 24 and the inside of the gear ring 21 on each side of the intermediate wall 24.

Various alternative fastening connections between the parts have been described above and may with advantage be used in combination with one another for greater security at the fastenings. If threaded connections are used, the inside of the gear ring and/or the outside of the hub are with advantage provided with a radially directed flange against which the intermediate wall rests. The screws are tightened in an axial direction through the flange and the intermediate wall in order to fasten the various parts securely together.

The invention has been described on the basis of an embodiment of the gear wheel. However, further modifications are conceivable in, for example, the dimensions and detailed configuration of the various parts. Furthermore, the intermediate wall of the gear wheel may be displaced from the central plane of the gear wheel with a view to further optimising the gear wheel according to prevailing load conditions.

Although it has been described on the basis of various exemplifying embodiments, the invention is not limited thereto but is defined on the basis of the accompanying claims.

1. A gear wheel comprising:
a hub with respective first and second axial ends and the hub is arranged round an axis of rotation,
a circular gear ring with respective first and second axial ends and with an outer periphery provided with a toothed rim; and
at least one intermediate wall linking the gear ring and the hub such that the hub is fixed at substantially the center of the gear ring;
at least one of the respective first and second axial ends of the hub has an integral coupling device configured for locking the gear wheel rotationally in relation to the hub of an adjacent gear wheel, the axial end of the hub which comprises the coupling devices has an end at or within the plane which is defined by the corresponding axial end of the gear ring transversely in relation to the longitudinal shaft around which the gear wheel is arranged; and
the gear ring and the hub are two separate parts joined together by a fastening connection to form a gear wheel.

2. A gear wheel according to claim 1, wherein the gear ring, intermediate wall and/or the hub are made from different materials.

3. A gear wheel according to claim 1 further comprising two of the intermediate walls joining the gear ring and the hub and the walls extend in a substantially radial direction from the hub to the gear ring.

4. A gear wheel according to claim 1, wherein the fastening connection comprises a press fastening.

5. A gear wheel according to claim 1, wherein the fastening connection comprises a welded connection.

6. A gear wheel according to claim 1, wherein the fastening connection comprises an adhesive connection.

7. A gear wheel according to claim 1, wherein the fastening connection comprises a threaded connection.

8. A gear wheel according to claim 1, wherein the gear ring includes an inside that has one or more protruding bulges against which the intermediate wall can bear.

9. A gear wheel according to claim 1, wherein the intermediate wall has one or more recesses which reduce the weight of the gear wheel and the amount of material used.

10. A gearbox comprising at least two gear wheels according to claim 1.
